(19) United States
(12) Patent Application Publication
(10) Pub. No.: US 2023/0327536 A1
(43) Pub. Date: Oct. 12, 2023

(54) POWER SUPPLY APPARATUS

(71) Applicant: HONDA MOTOR CO., LTD., Minato-ku, Tokyo (JP)

(72) Inventor: Yasumichi Onuki, Wako-shi, Saitama (JP)

(21) Appl. No.: 18/022,535

(22) PCT Filed: Jun. 22, 2021
(86) PCT No.: PCT/JP2021/023563

§ 371 Date: Feb. 22, 2023

(30) Foreign Application Priority Data
Sep. 11, 2020 (JP) 2020-152752

(51) Int. Cl. H02M 1/00; H02M 3/335

(52) U.S. Cl. CPC H02M 1/0048; H02M 3/33569

(57) ABSTRACT

A power supply apparatus (2) for supplying power to a plurality of loads (modn), the power supply apparatus including: a power source (4); an AC generation circuit (6) which is connected to the power source (4) and generates an AC voltage; an AC electric path (7) which is connected to the plurality of loads (modn) and to which the AC voltage is applied; and a transformer (8) which is provided between the AC generation circuit (6) and the AC electric path (7), in which an isolated DC/DC converter is not provided between the power source (4) and the AC generation circuit (6).

### TECHNICAL FIELD

The present invention relates to a power supply apparatus. The present invention claims priority based on Japanese Patent Application No. 2020-152752 filed in Japan on Sep. 11, 2020, the contents of which are incorporated herein by reference.

### BACKGROUND ART

In recent years, vehicles that travel using at least the driving force of a motor, such as an electric vehicle (EV), a hybrid electric vehicle (HEV), a plug-in hybrid electric vehicle (PHEV), and a fuel cell vehicle (FCV), have been put into practical use. For example, Patent Document 1 discloses a structure in which a solar cell is mounted on a vehicle and a high-voltage battery for motor driving is charged using an isolated DC/DC converter. For example, Patent Documents 2 and 3 disclose a structure in which power can be supplied from a power source to a plurality of circuits (loads). For example, Patent Document 4 discloses a structure in which a cut-off switch is provided between adjacent battery modules, and an isolation transformer is provided between control terminals corresponding to the adjacent battery modules.

### RELATED ART DOCUMENT

### Patent Document

[Patent Document 1]

PCT International Publication No. WO 2011/102458

[Patent Document 2]

Japanese Patent (Granted) Publication No. 4892595

[Patent Document 3]

Japanese Patent (Granted) Publication No. 5351952

[Patent Document 4]

Japanese Patent (Granted) Publication No. 5624678

### SUMMARY

### Problems to be Solved by the Invention

Incidentally, in a constitution in which power is supplied from a power source to a load via a transformer such as an isolation transformer, it is required to reduce the number and the size of components and reduce power loss.

Therefore, an object of the present invention is to provide a power supply apparatus capable of reducing the number and the size of components and reducing power loss.

### Means for Solving the Problem

(1) A power supply apparatus (for example, power supply apparatus 2 of embodiments) according to an aspect of the present invention is a power supply apparatus for supplying power to a plurality of loads (for example, battery modules modn of embodiments), the power supply apparatus including: a power source (for example, solar power generation unit 4 of embodiments); an AC generation circuit (for example, AC generation circuit 6 of embodiments) which is connected to the power source and generates an AC voltage; an AC electric path (for example, AC electric path 7 of embodiments) which is connected to the plurality of loads and to which the AC voltage is applied; and a transformer (for example, transformer 8 of embodiments) which is provided between the AC generation circuit and the AC electric path, in which an isolated DC/DC converter is not provided between the power source and the AC generation circuit.

(2) According to an aspect of the present invention, the plurality of loads may include battery modules (for example, battery modules modn of embodiments) connected in series, a cut-off switch (for example, cut-off switch 9 of embodiments) may be provided between the battery modules adjacent to each other, and the transformer (for example, transformer 8 of embodiments) may include only one three-winding transformer.

(3) According to an aspect of the present invention, the plurality of loads may include battery modules connected in series, a cut-off switch may be provided between the battery modules adjacent to each other, and the transformer (for example, transformer 208 of embodiments) may include only two two-winding transformers.

(4) According to an aspect of the present invention, the cut-off switch may be a service plug.

(5) According to an aspect of the present invention, the plurality of loads may include battery modules connected in series, a cut-off switch may not be provided between the battery modules adjacent to each other, and the transformer (for example, transformer 308 of embodiments) may include only one two-winding transformer.

### Advantage of the Invention

According to the aspect of (1) above, since the isolated DC/DC converter is not provided between the power source and the AC generation circuit, the number of transformers can be reduced and the size of the transformer can be reduced as compared with the case where the isolated DC/DC converter is provided between the power source and the AC generation circuit. In addition, the power loss generated in the transformer can be reduced. Accordingly, the number and the size of components can be reduced and the power loss can be reduced.

According to the aspect of (2) above, the plurality of loads includes the battery modules connected in series, the cut-off switch is provided between the battery modules adjacent to each other, and the transformer includes only one three-winding transformer, so that the effects described below are obtained. When power is supplied from the power source to the plurality of loads, the power is supplied via only the one three-winding transformer. Even when the cut-off switch is provided between the battery modules adjacent to each other, it is possible to suppress application of an excessive high voltage to the battery modules while minimizing the number of transformers.

According to the aspect of (3) above, the plurality of loads includes the battery modules connected in series, the cut-off switch is provided between the battery modules adjacent to each other, and the transformer includes only two two-winding transformers, so that the effects described below are obtained. When power is supplied from the power source to the plurality of loads, the power is supplied via only the two two-winding transformers. Even when the cut-off switch is provided between the battery modules adjacent to each other, it is possible to suppress application of an excessively high voltage to the battery modules while reducing the number of transformers as much as possible.

According to the aspect of (4) above, the cut-off switch is a service plug, so that the effects described below are obtained. It is easy to perform inspection and maintenance (service) between the battery modules adjacent to each other.

According to the aspect of (5) above, the plurality of loads includes the battery modules connected in series, the cut-off switch is not provided between the battery modules adjacent to each other, and the transformer includes only one two-winding transformer, so that the effects described below are obtained. When power is supplied from the power source to the plurality of loads, the power is supplied via only the one two-winding transformer. When the cut-off switch is not provided between the battery modules adjacent to each other, it is possible to suppress application of an excessive high voltage to the battery modules while minimizing the number of transformers.

### BRIEF DESCRIPTION OF THE DRAWINGS

FIG. 1 is a block diagram of a power supply system of a first embodiment.

FIG. 2 is a constitutional diagram of the power supply system of the first embodiment.

FIG. 3 is a circuit diagram illustrating an example of a control circuit of the first embodiment.

FIG. 4 is a circuit diagram illustrating an example of an AC generation circuit of the first embodiment.

FIG. 5 is a circuit diagram illustrating an example of a circuit module of the first embodiment.

FIG. 6 is a diagram illustrating a relationship between an input voltage to the AC generation circuit and a charging current to the battery module of the first embodiment.

FIG. 7 is a diagram illustrating a relationship between a voltage of each battery module and a charging current to each battery module of the first embodiment.

FIG. 8 is a side cross-sectional diagram illustrating an example of a cut-off switch of the first embodiment and is a diagram illustrating a state in which a first case and a second case are connected.

FIG. 9 is a side cross-sectional diagram illustrating an example of the cut-off switch of the first embodiment and is a diagram illustrating a state in which the first case and the second case are separated.

FIG. 10 is a block diagram of a power supply system of a first modification of the first embodiment.

FIG. 11 is a block diagram of a power supply system of a second modification of the first embodiment.

FIG. 12 is a block diagram of a power supply system of a third modification of the first embodiment.

FIG. 13 is a block diagram of a power supply system of a second embodiment.

FIG. 14 is a block diagram of a power supply system of a third embodiment.

### DESCRIPTION OF THE EMBODIMENTS

Hereinafter, embodiments of the present invention will be described with reference to the drawings. In the embodiments, a power supply system including a power supply apparatus that supplies power to a plurality of loads and mounted on an electric vehicle (vehicle) will be described. Hereinafter, in the drawings, the same constituent elements are denoted by the same reference numbers in principle, and redundant description will be omitted.

<First Embodiment>

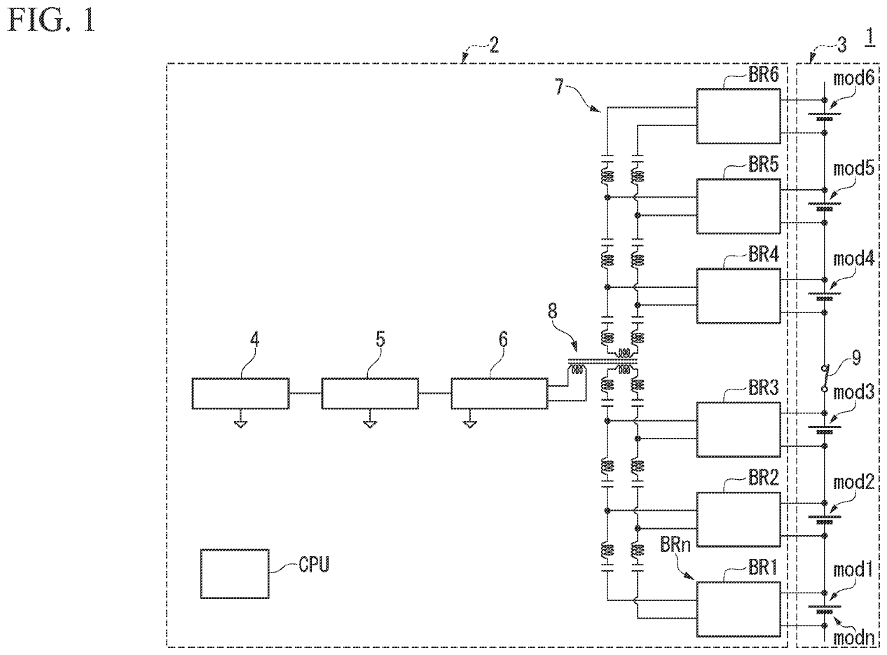

As illustrated in FIG. 1, a power supply system 1 includes a power supply apparatus 2 and an assembled battery 3.

The power supply apparatus 2 includes a solar power generation unit 4 (power source), a control circuit 5, an AC generation circuit 6, circuit modules BRn, an AC electric path 7, a transformer 8, a cut-off switch 9, and a controller CPU. The controller CPU controls the constituent elements of the power supply apparatus 2.

<Solar Power Generation Unit>

The solar power generation unit 4 is disposed on an outer upper surface of the vehicle so as to be able to sufficiently receive sunlight. For example, the solar power generation unit 4 is disposed on the roof of the vehicle. Note that the solar power generation unit 4 may be disposed in the vehicle interior such as on the hood of the vehicle, under the windshield (above the dashboard), or under the rear window. For example, as long as the solar cell can be constituted to be integral with the window, the window may also serve as the solar power generation unit 4. For example, the disposition position of the solar power generation unit 4 can be changed according to required specifications.

Although not illustrated, the solar power generation unit 4 includes a plurality of solar cells and a diode for preventing backflow. The solar power generation unit 4 is a power generation apparatus that generates power from sunlight. From the viewpoint of electrical safety, it is preferable that the power generation voltage of the solar power generation unit 4 be low and the solar power generation unit 4 be grounded to the vehicle body.

<Control Circuit>

The control circuit 5 is connected to the solar power generation unit 4. The control circuit 5 is a max peak power tracking (MPPT) circuit that optimizes an output voltage of the solar power generation unit 4. The control circuit 5 performs control (maximum power point tracking control) for extracting power at an output voltage at which the power generated by the solar power generation unit 4 is maximized For example, the control circuit 5 is a non-isolated DC/DC converter. Note that, from the viewpoint of electrical safety, the control circuit 5 is preferably grounded to the vehicle body.

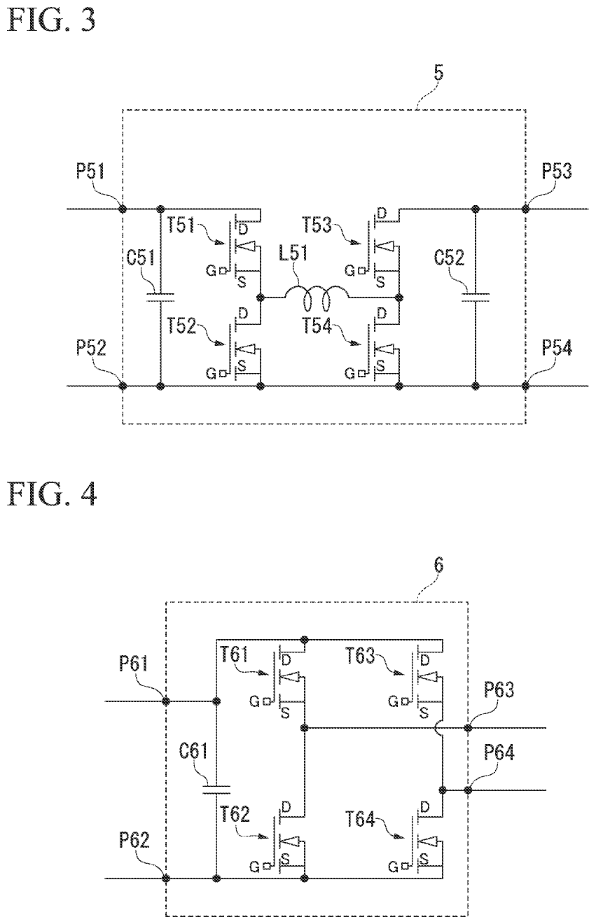

In the example of FIG. 3, the control circuit 5 includes four terminals P51 to P54 (first terminal P51, second terminal P52, third terminal P53, and fourth terminal P54), four transistors T51 to T54 (first transistor T51, second transistor T52, third transistor T53, and fourth transistor TM), two capacitors C51 and C52 (first capacitor C51 and second capacitor C52), and one inductor L51. Note that the types and the number of constituent elements of the control circuit 5 are not limited to those described above. For example, the constitution of the control circuit 5 can be changed according to required specifications.

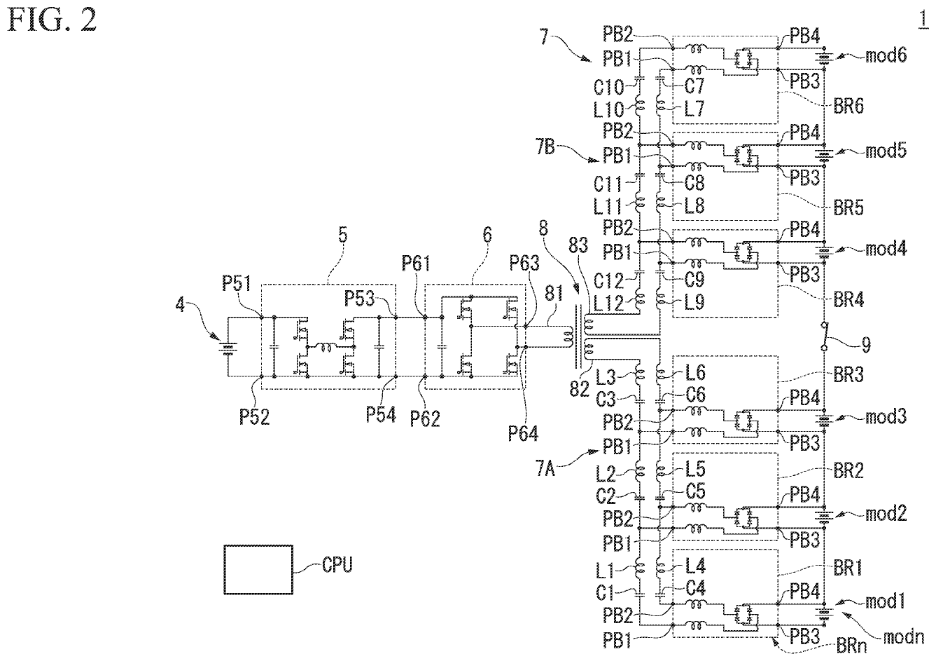

As illustrated in FIG. 2, the first terminal P51 of the control circuit 5 is connected to a positive terminal of the solar power generation unit 4. The second terminal P52 of the control circuit 5 is connected to a negative terminal of the solar power generation unit 4.

For example, the transistors T51 to T54 are N-channel metal oxide semiconductor (MOS) field effect transistors (FETs). In FIG. 3, the gate, the source, and the drain of each of the transistors T51 to T54 are denoted by “G”, “S”, and “D”, respectively.

As illustrated in FIG. 3, the drain terminal of the first transistor T51 is connected to the first terminal P51. The source terminal of the first transistor T51 is connected to the drain terminal of the second transistor T52. The source terminal of the second transistor T52 is connected to the second terminal P52. The drain terminal of the third transistor T53 is connected to the third terminal P53. The source terminal of the third transistor T53 is connected to the drain terminal of the fourth transistor T54. The source terminal of the fourth transistor T54 is connected to the fourth terminal P54.

In the control circuit 5, a wiring connecting the first terminal P51 and the drain terminal of the first transistor T51 is referred to as a “first wiring”, a wiring connecting the second terminal P52 and the source terminal of the second transistor T52 is referred to as a “second wiring”, a wiring connecting the third terminal P53 and the drain terminal of the third transistor T53 is referred to as a “third wiring”, and a wiring connecting the fourth terminal P54 and the source terminal of the fourth transistor T54 is referred to as a “fourth wiring”.

The first capacitor C51 is provided on a wiring connecting the middle of the first wiring and the middle of the second wiring. The second capacitor C52 is provided on a wiring connecting the middle of the third wiring and the middle of the fourth wiring.

For example, the inductor L51 is a wiring inductor. The source terminal of the first transistor T51 and the drain terminal of the second transistor T52 are connected to the source terminal of the third transistor T53 and the drain terminal of the fourth transistor T54 via the inductor L51.

<AC Generation Circuit>

As illustrated in FIG. 1, the AC generation circuit 6 is connected to the control circuit 5. The AC generation circuit 6 is connected to the solar power generation unit 4 via the control circuit 5. The AC generation circuit 6 generates an AC voltage using the voltage from the control circuit 5. An isolated DC/DC converter is not provided between the solar power generation unit 4 and the AC generation circuit 6. Note that, from the viewpoint of electrical safety, the AC generation circuit 6 is preferably grounded to the vehicle body.

In the example of FIG. 4, the AC generation circuit 6 includes four terminals P61 to P64 (first terminal P61, second terminal P62, third terminal P63, and fourth terminal P64), four transistors T61 to T64 (first transistor T61, second transistor T62, third transistor T63, and fourth transistor T64), and one capacitor C61. Note that the types and the number of constituent elements of the AC generation circuit 6 are not limited to those described above. For example, the constitution of the AC generation circuit 6 can be changed according to required specifications.

As illustrated in FIG. 2, the first terminal P61 of the AC generation circuit 6 is connected to the third terminal P53 of the control circuit 5. The second terminal P62 of the AC generation circuit 6 is connected to the fourth terminal P54 of the control circuit 5.

For example, the transistors T61 to T64 are N-channel MOSFETs. In FIG. 4, the gate, the source, and the drain of each of the transistors T61 to T64 are denoted by “G”, “S”, and “D”, respectively.

As illustrated in FIG. 4, the drain terminal of the first transistor T61 is connected to the first terminal P61. The source terminal of the first transistor T61 is connected to the drain terminal of the second transistor T62. The source terminal of the second transistor T62 is connected to the second terminal P62. The drain terminal of the third transistor T63 is connected to the drain terminal of the first transistor T61. The source terminal of the third transistor T63 is connected to the drain terminal of the fourth transistor T64. The source terminal of the fourth transistor T64 is connected to the source terminal of the second transistor T62.

In the AC generation circuit 6, a wiring connecting the first terminal P61 and the drain terminal of the first transistor T61 is referred to as a “first wiring”, and a wiring connecting the second terminal P62 and the source terminal of the second transistor T62 is referred to as a “second wiring”.

The capacitor C61 is provided on a wiring connecting the middle of the first wiring and the middle of the second wiring.

The source terminal of the first transistor T61 and the drain terminal of the second transistor T62 are connected to the third terminal P63. The source terminal of the third transistor T63 and the drain terminal of the fourth transistor T64 are connected to the fourth terminal P64.

<Assembled Battery>

As illustrated in FIG. 1, the assembled battery 3 includes a battery module modn (load) including a plurality of battery cells. In the assembled battery 3, a plurality of battery modules modn is connected in series. For example, the assembled battery 3 is disposed in a lower part of the vehicle in consideration of weight balance. For example, the assembled battery 3 is a high-voltage battery of about 100 V to several hundred V. For example, the assembled battery 3 is a battery for driving a motor of a vehicle. The assembled battery 3 is insulated from a metal material (conductive material) constituting the vehicle body. From the viewpoint of preventing electric shock, the assembled battery 3 is insulated from the vehicle body. Although not illustrated, a live part of the assembled battery 3 is constituted to be completely covered with an insulator and not exposed. Note that the power supply system 1 does not include a sub-battery different from the assembled battery 3 (driving battery).

For example, the battery cells constituting the battery module modn includes a lithium ion secondary battery. For example, the plurality of battery modules modn is constituted according to the same standard. In the example of FIG. 1, the assembled battery 3 includes six battery modules modl to mod6 (first battery module modl, second battery module mod2, third battery module mod3, fourth battery module mod4, fifth battery module mod5, and sixth battery module mod6). Note that the number of battery modules modn constituting the assembled battery 3 is not limited to those described above. For example, the number of battery modules modn constituting the assembled battery 3 can be changed according to required specifications.

The cut-off switch 9 is provided between the battery modules modn adjacent to each other. In the example of FIG. 1, one cut-off switch 9 is provided between the third battery module mod3 and the fourth battery module mod4. The controller CPU controls ON/OFF (closed state/open state) of the cut-off switch 9. For example, when the cut-off switch 9 is ON (closed state, connected state), the third battery module mod3 and the fourth battery module mod4 are electrically connected. On the other hand, when the cut-off switch 9 is OFF (open state, unconnected state), the third battery module mod3 and the fourth battery module mod4 are electrically cut off.

<Circuit Module>

The circuit modules BRn are provided corresponding to the plurality of battery modules modn. In the example of FIG. 1, six circuit modules BR1 to BR6 (first circuit module BR1, second circuit module BR2, third circuit module BR3, fourth circuit module BR4, fifth circuit module BRS, and sixth circuit module BR6) are provided corresponding to the six battery modules modl to mod6. Note that the number of circuit modules BRn is not limited to those described above. For example, the number of circuit modules BRn can be changed according to required specifications.

The first circuit module BR1, the second circuit module BR2, the third circuit module BR3, the fourth circuit module BR4, the fifth circuit module BRS, and the sixth circuit module BR6 are connected to the first battery module modl, the second battery module mod2, the third battery module mod3, the fourth battery module mod4, the fifth battery module mod5, and the sixth battery module mod6, respectively.

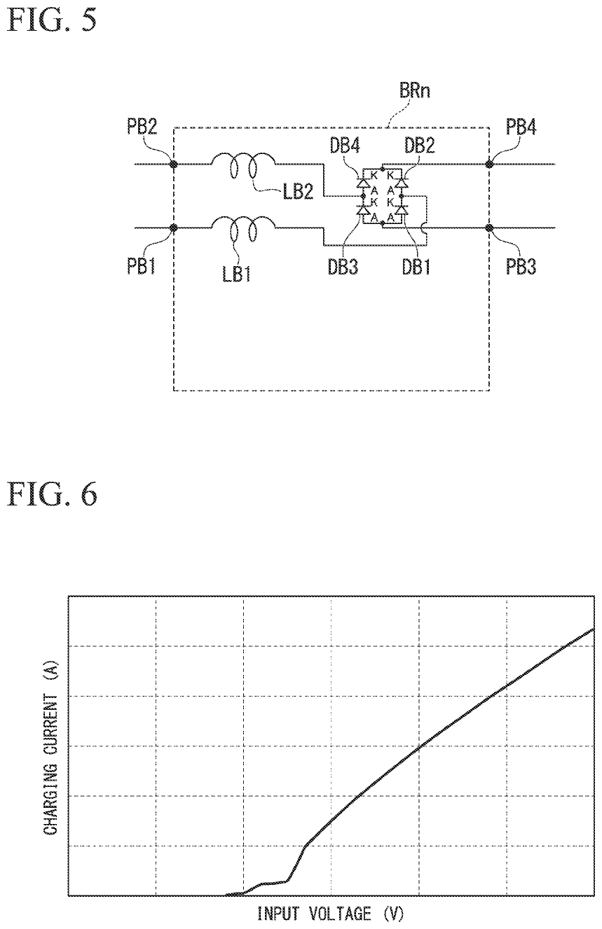

In the example of FIG. 5, the circuit module BRn includes four terminals PB1 to PB4 (first terminal PB1, second terminal PB2, third terminal PB3, and fourth terminal PB4), two inductors LB1 and LB2 (first inductor LB1 and second inductor LB2), and four diodes DB1 to DB4 (first diode DB1, second diode DB2, third diode DB3, and fourth diode DB4). The circuit module BRn functions as a rectifier circuit that causes a current to flow from the anode (positive electrode) to the cathode (negative electrode) of the diodes DB1 to DB4. Note that the types and the number of constituent elements of the circuit module BRn are not limited to those described above. For example, the constitution of the circuit module BRn can be changed according to required specifications. In FIG. 5, the anode and cathode of the diode are denoted by “A” and “K”, respectively.

As illustrated in FIG. 5, the first terminal PB1 is connected between a cathode end of the first diode DB1 and an anode end of the second diode DB2 via the first inductor LB1. The second terminal PB2 is connected between a cathode end of the third diode DB3 and an anode end of the fourth diode DB4 via the second inductor LB2. The third terminal PB3 is connected between an anode end of the first diode DB1 and an anode end of the third diode DB3. The fourth terminal PB4 is connected between a cathode end of the second diode DB2 and a cathode end of the fourth diode DB4.

As illustrated in FIG. 2, the third terminal PB3 of the circuit module BRn is connected to the negative terminal of the battery module modn. The fourth terminal PB4 of the circuit module BRn is connected to the positive terminal of the battery module modn. <AC Electric Path>

The AC electric path 7 is connected to a plurality of loads including the circuit module BRn and the battery module modn. An AC voltage generated by the AC generation circuit 6 is applied to the AC electric path 7 via the transformer 8. The AC electric path 7 is provided with a series circuit (LC circuit) of capacitors and inductors.

In the example of FIG. 2, two electric paths 7A and 7B (first electric path 7A and second electric path 7B) are provided as the AC electric path 7, and six capacitors C1 to C6 (first capacitor C1, second capacitor C2, third capacitor C3, fourth capacitor C4, fifth capacitor C5, and sixth capacitor C6) and six inductors L1 to L6 (first inductor L1, second inductor L2, third inductor L3, fourth inductor L4, fifth inductor L5, and sixth inductor L6) connected in series in a first system (on the first electric path 7A) and six capacitors C7 to C12 (seventh capacitor C7, eighth capacitor C8, ninth capacitor C9, tenth capacitor C10, eleventh capacitor C11, and twelfth capacitor C12) and six inductors L7 to L12 (seventh inductor L7, eighth inductor L8, ninth inductor L9, tenth inductor L10, eleventh inductor

L11, and twelfth inductor L12) connected in series in a second system (on the second electric path 7B) are provided as a series circuit of capacitors and inductors.

As illustrated in FIG. 2, a first end of the first electric path 7A is connected to the first terminal PB1 of the first circuit module BR1. A second end of the first electric path 7A is connected to the second terminal PB2 of the first circuit module BR1.

A first end of the second electric path 7B is connected to the first terminal PB1 of the sixth circuit module BR6. A second end of the second electric path 7B is connected to the second terminal PB2 of the sixth circuit module BR6.

The first capacitor C1, the first inductor L1, the second capacitor C2, the second inductor L2, the third capacitor C3, and the third inductor L3 are disposed on the first electric path 7A in this order from the first end of the first electric path 7A toward the transformer 8 (second winding 82). The first capacitor C1 and the first inductor L1 are connected between the first terminal PB1 of the first circuit module BR1 and the first terminal PB1 of the second circuit module BR2. The second capacitor C2 and the second inductor L2 are connected between the first terminal PB1 of the second circuit module BR2 and the first terminal PB1 of the third circuit module BR3. The third capacitor C3 and the third inductor L3 are connected between the first terminal PB1 of the third circuit module BR3 and the second winding 82 of the transformer 8.

The fourth capacitor C4, the fourth inductor L4, the fifth capacitor C5, the fifth inductor L5, the sixth capacitor C6, and the sixth inductor L6 are disposed on the first electric path 7A in this order from the second end of the first electric path 7A toward the transformer 8 (second winding 82). The fourth capacitor C4 and the fourth inductor L4 are connected between the second terminal PB2 of the first circuit module BR1 and the second terminal PB2 of the second circuit module BR2. The fifth capacitor C5 and the fifth inductor L5 are connected between the second terminal PB2 of the second circuit module BR2 and the second terminal PB2 of the third circuit module BR3. The sixth capacitor C6 and the sixth inductor L6 are connected between the second terminal PB2 of the third circuit module BR3 and the second winding 82 of the transformer 8.

The seventh capacitor C7, the seventh inductor L7, the eighth capacitor C8, the eighth inductor L8, the ninth capacitor C9, and the ninth inductor L9 are disposed on the second electric path 7B in this order from the first end of the second electric path 7B toward the transformer 8 (third winding 83). The seventh capacitor C7 and the seventh inductor L7 are connected between the first terminal PB1 of the sixth circuit module BR6 and the first terminal PB1 of the fifth circuit module BR5. The eighth capacitor C8 and the eighth inductor L8 are connected between the first terminal PB1 of the fifth circuit module BR5 and the first terminal PB1 of the fourth circuit module BR4. The ninth capacitor C9 and the ninth inductor L9 are connected between the first terminal PB1 of the fourth circuit module BR4 and the third winding 83 of the transformer 8.

The tenth capacitor C10, the tenth inductor L10, the eleventh capacitor C11, the eleventh inductor L11, the twelfth capacitor C12, and the twelfth inductor L12 are disposed on the second electric path 7B in this order from the second end of the second electric path 7B toward the transformer 8 (third winding 83). The tenth capacitor C10 and the tenth inductor L10 are connected between the second terminal PB2 of the sixth circuit module BR6 and the second terminal PB2 of the fifth circuit module BR5. The eleventh capacitor C11 and the eleventh inductor L11 are connected between the second terminal PB2 of the fifth circuit module BR5 and the second terminal PB2 of the fourth circuit module BR4. The twelfth capacitor C12 and the twelfth inductor L12 are connected between the second terminal PB2 of the fourth circuit module BR4 and the third winding 83 of the transformer 8.

As described above, the power supply apparatus 2 (see FIG. 1) includes the plurality of circuit modules BRn provided corresponding to the plurality of battery modules modn connected in series, the AC electric path 7 connected to the plurality of circuit modules BRn, and the AC generation circuit 6 that applies an AC voltage to the AC electric path 7. The AC electric path 7 has a constitution in which the capacitors and the inductors are connected in series. For example, the product of the combined capacitance of the plurality of capacitors connected in series from the AC generation circuit 6 to the respective circuit modules BRn (rectifier circuits) and the combined capacitance of the plurality of inductors is set to be equal in any combination of the AC generation circuit 6 and the circuit module BRn (rectifier circuit). The AC electric path 7 is constituted to transmit two or more phases of AC. The AC generation circuit 6 is constituted to generate an AC having a frequency approximate to a resonance frequency of a series circuit of capacitors and inductors.

Thus, since the resonance frequency is the same in any combination of the battery modules modn, the charging current having the same value can flow to all the battery modules modn. For example, when the resonance frequency of the AC generation circuit 6 of each battery module modn is set to the same value, the charge/discharge current having the same value can flow in a charge/discharge route of any combination of battery modules modn, so that the charge voltage of the battery modules modn can be made uniform.

<Relationship between Input Voltage to AC Generation Circuit and Charging Current to Battery Module>

For example, the charging current to the battery module modn with respect to the input voltage to the AC generation circuit 6 is as illustrated in FIG. 6. The example of FIG. 6 illustrates a substantially linear characteristic in which the charging current to the battery module modn gradually increases as the input voltage to the AC generation circuit 6 increases. Thus, by adjusting the output voltage of the control circuit 5, an increase and decrease in charging current to the battery module modn can be easily controlled.

<Relationship between Voltage of each Battery Module and Charging Current to each Battery Module>

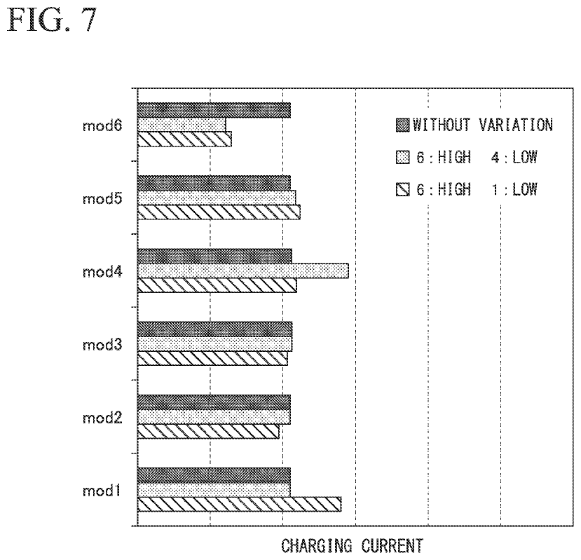

For example, the relationship between the voltage of each battery module modn and the charging current to each battery module modn is as illustrated in FIG. 7. As illustrated in FIG. 7, when there is no variation in voltage of each battery module modn, battery modules modn are uniformly charged.

Hereinafter, a case where there is a variation in voltage of battery modules modn will be described.

As an example, when the voltage of the sixth battery module mod6 is high and the voltage of the fourth battery module mod4 is low, a charging current smaller than others flows through the sixth battery module mod6, and a charging current larger than others flows through the fourth battery module mod4.

As another example, when the voltage of the sixth battery module mod6 is high and the voltage of the first battery module modl is low, a charging current smaller than others flows through the sixth battery module mod6, and a charging current larger than others flows through the first battery module modl.

In this way, the battery module modn with a high voltage is charged less than the others, and the battery module modn with a low voltage is charged more than the others. Therefore, even when the control is not intentionally performed, the voltages of the battery modules modn are made uniform. <Transformer>

As illustrated in FIG. 2, the transformer 8 is provided between the AC generation circuit 6 and the AC electric path 7. A connection point between the transformer 8 and the AC electric path 7 is disposed at an intermediate position where the cut-off switch 9 is provided. The transformer 8 includes only one three-winding transformer. The transformer 8 includes a first winding 81, the second winding 82, and the third winding 83. The first winding 81 is provided on an input side (primary side) of the transformer 8. The second winding 82 and the third winding 83 are provided on an output side (secondary side) of the transformer 8.

The first winding 81 is connected to the AC generation circuit 6. As illustrated in FIG. 2, a first end of the first winding 81 is connected to the third terminal P63 of the AC generation circuit 6. A second end of the first winding 81 is connected to the fourth terminal P64 of the AC generation circuit 6.

The second winding 82 is connected between the third inductor L3 and the sixth inductor L6 in the first electric path 7A.

The third winding 83 is connected between the ninth inductor L9 and the twelfth inductor L12 in the second electric path 7B.

As described above, the cut-off switch 9 is provided between the third battery module mod3 and the fourth battery module mod4 adjacent to each other. When the cut-off switch 9 is opened, a path for transmitting AC is separated (insulated) into the second winding 82 side and the third winding 83 side in terms of DC by the transformer 8. Therefore, the voltage of the third battery module mod3 is merely applied to the capacitors C3 and C6, and a high voltage is not applied to the capacitors C3 and C6. In addition, the voltage of the fourth battery module mod4 is merely applied to the capacitors C9 and C12, and a high voltage is not applied to the capacitors C9 and C12.

Since the capacitors are connected in series in both windings 82 and 83 of the transformer 8, a direct current is not continuously applied to the windings of the transformer 8 regardless of the output state of the AC generation circuit 6.

With this constitution, when the cut-off switch 9 interposed between at least one set of adjacent battery modules modn is opened, a high voltage is not applied to the capacitors under the DC insulation action of the transformer 8 interposed between the terminals corresponding to the adjacent battery modules modn, and therefore, it is not necessary to use a high withstand voltage capacitor even when the cut-off switch 9 is interposed.

<Cut-Off Switch>

As illustrated in FIG. 2, the cut-off switch 9 is provided between the third battery module mod3 and the fourth battery module mod4 adjacent to each other. The cut-off switch 9 is a switch capable of electrically cutting off connection between the third battery module mod3 and the fourth battery module mod4. For example, the cut-off switch 9 is a service plug.

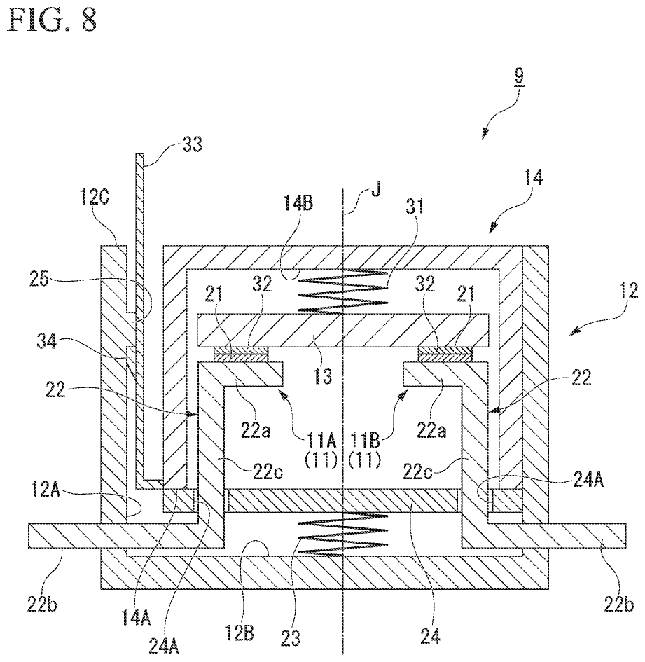

As illustrated in FIG. 8, the cut-off switch 9 includes a first case 12 and a second case 14 that are detachable from each other. Hereinafter, a direction along a straight line J in FIG. 8 is referred to as a “first direction”, and a direction orthogonal to the first direction is referred to as a “second direction”.

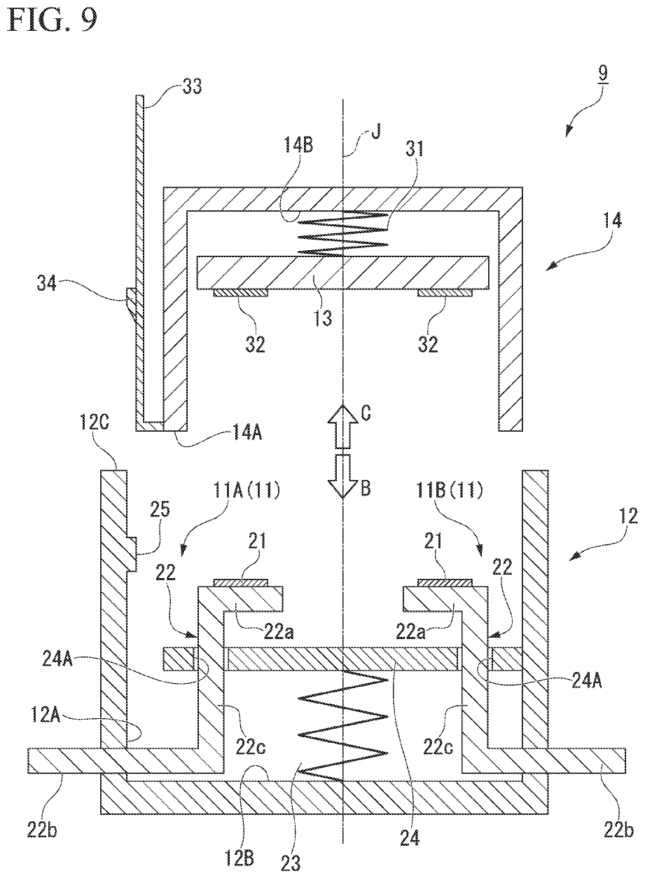

For example, as illustrated in FIG. 9, the second case 14 can be attached to the first case 12 by bringing the second case 14 close to the first case 12 in one (direction of arrow B) of the first direction. On the other hand, the second case 14 can be detached from the first case 12 by separating the second case 14 from the first case 12 in the other (direction of arrow C) of the first direction.

As illustrated in FIG. 9, the first case 12 includes a pair of connection electrodes 11A and 11B (first connection electrode 11A and second connection electrode 11B) connectable to an external electric circuit. For example, the first connection electrode 11A is connected to the positive terminal of the third battery module mod3 (see FIG. 2) through a wiring, which is not illustrated. For example, the second connection electrode 11B is connected to the negative terminal of the fourth battery module mod4 (see FIG. 2) through a wiring, which is not illustrated.

The first case 12 is formed, for example, of an electrical insulation material in a box shape having an opening in the direction of arrow C. The pair of connection electrodes 11 is disposed inside the first case 12. The pair of connection electrodes 11 is disposed at a distance in the second direction.

The connection electrode 11 includes an electrode portion 21 and an electrode support portion 22 that supports the electrode portion 21. The electrode portion 21 is provided to protrude in the direction of arrow C from a first end portion 22a of the electrode support portion 22.

The electrode support portion 22 includes a shaft portion 22c that extends in the first direction and connects the first end portion 22a and a second end portion 22b. The second end portion 22b extends in the second direction in the vicinity of a bottom portion 12B of the first case 12. The second end portion 22b penetrates a wall portion 12A of the first case 12 and protrudes to the outside.

For example, the protrusion end of the second end portion 22b of the first connection electrode 11A is fixed to a frame, which is not illustrated, and connected to the positive terminal of the third battery module mod3 (see FIG. 2) through a wiring. For example, the protrusion end of the second end portion 22b of the second connection electrode 11B is fixed to a frame, which is not illustrated, and connected to the negative terminal of the fourth battery module mod4 (see FIG. 2) through a wiring.

A first spring 23 elastically deformable in the first direction is provided inside the first case 12. An abutment member 24 is coupled to the bottom portion 12B of the first case 12 via the first spring 23. The wall portion 12A of the first case 12 is provided with a protrusion portion 25 protruding inward from an inner wall surface.

The abutment member 24 is formed in a plate shape extending in the second direction. The abutment member 24 is displaceable in the first direction along with the elastic deformation of the first spring 23. The abutment member 24 has through-holes 24A into which the respective shaft portions 22c of the pair of connection electrodes 11 are inserted. The abutment member 24 is movable in the first direction within the range of the length of the shaft portion 22c.

The second case 14 includes a short-circuit member 13 capable of electrically short-circuiting the pair of connection electrodes 11. The second case 14 is formed, for example, of an electrical insulation material in a box shape having an opening in the direction of arrow B. A second spring 31 elastically deformable in the first direction is provided inside the second case 14. The short-circuit member 13 is coupled to a bottom portion 14B of the second case 14 via the second spring 31.

The short-circuit member 13 is formed in a plate shape extending in the second direction. The short-circuit member 13 is displaceable in the first direction along with the elastic deformation of the second spring 31. The short-circuit member 13 includes short-circuit electrode portions 32 that abut on the respective electrode portions 21 of the pair of connection electrodes 11.

The second case 14 can be inserted into the first case 12. In a state where the opening of the second case 14 is disposed to face the opening of the first case 12, an opening end 14A of the second case 14 can abut on the abutment member 24 of the first case 12.

A lever 33 elastically displaceable in the second direction is provided on an outer wall surface of the second case 14. The lever 33 is formed in an L shape in a cross-sectional view. A first end of the lever 33 is fixed to the outer wall surface of the second case 14. A second end of the lever 33 is disposed so as to protrude in the direction of arrow C beyond the bottom portion 14B of the second case 14. The lever 33 is provided with a claw portion 34 that engages with the protrusion portion 25 protruding from the inner wall surface of the first case 12 and restricts displacement of the second case 14 in the direction of arrow C.

Hereinafter, an example of a method for attaching the second case 14 to the first case 12 will be described.

First, as illustrated in FIG. 9, the second case 14 is moved in the direction of arrow B with the opening of the second case 14 facing the opening of the first case 12, and the second case 14 is inserted into the first case 12. Next, the opening end 14A of the second case 14 is brought into contact with the abutment member 24 of the first case 12, and the second case 14 is pushed in the direction of arrow B. Then, the first spring 23 supporting the abutment member 24 is compressed. Then, as a result of the movement of the second case 14 in the direction of arrow B, the claw portion 34 of the lever 33 comes into contact with the protrusion portion 25 of the first case 12, and the lever 33 elastically deforms in the second direction so that the claw portion 34 moves over the protrusion portion 25. At this time, as illustrated in FIG. 8, the short-circuit electrode portions 32 of the short-circuit member 13 of the second case 14 abut on the electrode portions 21 of the connection electrodes 11A and 11B of the first case 12. Thus, the pair of connection electrodes 11A and 11B are electrically short-circuited. When the claw portion 34 of the lever 33 moves over the protrusion portion 25 of the first case 12, the claw portion 34 engages with the projection portion 25. Thus, the second case 14 can be attached to the first case 12.

As described above, the first connection electrode 11A is connected to the positive terminal of the third battery module mod3 (see FIG. 2), and the second connection electrode 11B is connected to the negative terminal of the fourth battery module mod4 (see FIG. 2). Therefore, the third battery module mod3 and the fourth battery module mod4 can be electrically connected by attaching the second case 14 to the first case 12.

Hereinafter, an example of a method for detaching the second case 14 from the first case 12 will be described.

First, as illustrated in FIG. 8, the lever 33 is elastically deformed in the second direction from the state in which the claw portion 34 is engaged with the projection portion 25 and the second case 14 is fixed to the first case 12 to release the engagement state between the claw portion 34 and the projection portion 25. Then, as illustrated in FIG. 9, the second case 14 moves in the direction of arrow C with respect to the first case 12 by the restoring force of the first spring 23 and the second spring 31. Then, the claw portion 34 of the lever 33 moves over the protrusion portion 25 of the first case 12, and the electrode portions 21 of the connection electrodes 11 and the short-circuit electrode portions 32 of the short-circuit member 13 are separated from each other. Thus, the short-circuit state between the pair of connection electrodes 11A and 11B is released. Then, by moving the second case 14 in the direction of arrow C so as to be separated from the first case 12, the opening end 14A of the second case 14 is separated from the abutment member 24 of the first case 12. Thus, the second case 14 can be detached from the first case 12.

As described above, the first connection electrode 11A is connected to the positive terminal of the third battery module mod3 (see FIG. 2), and the second connection electrode 11B is connected to the negative terminal of the fourth battery module mod4 (see FIG. 2). Therefore, the third battery module mod3 and the fourth battery module mod4 can be electrically disconnected by detaching the second case 14 from the first case 12.

<Operation and Effects>

As described above, the power supply apparatus 2 of the above embodiment is the power supply apparatus 2 that supplies power to the plurality of loads and includes the solar power generation unit 4, the AC generation circuit 6 that is connected to the solar power generation unit 4 and generates an AC voltage, the AC electric path 7 that is connected to the plurality of loads and to which the AC voltage is applied, and the transformer 8 provided between the AC generation circuit 6 and the AC electric path 7, and the isolated DC/DC converter is not provided between the solar power generation unit 4 and the AC generation circuit 6.

With this constitution, the number of transformers can be reduced and the size of the transformer can be reduced as compared with the case where the isolated DC/DC converter is provided between the solar power generation unit 4 and the AC generation circuit 6. In addition, the power loss generated in the transformer can be reduced. Accordingly, the number and the size of components can be reduced and the power loss can be reduced.

For example, in a case where the generated power of the solar cell is boosted to a voltage similar to that of a high-voltage battery by an isolated DC/DC converter to generate a high voltage for charging, it is necessary to operate a monitoring system that monitors the voltage. When the monitoring system is operated while being left, power consumption increases and charging power decreases. On the other hand, according to the present embodiment, since the isolated DC/DC converter is not provided, it is possible to suppress an increase in power consumption and to suppress a decrease in charging power.

In the above embodiment, the plurality of loads includes the battery modules modn connected in series, the cut-off switch 9 is provided between the battery modules modn adjacent to each other, and the transformer 8 includes only one three-winding transformer, so that the effects described below are obtained.

When power is supplied from the solar power generation unit 4 to the plurality of loads, the power is supplied via only the one three-winding transformer. Even when the cut-off switch 9 is provided between the battery modules modn adjacent to each other, it is possible to suppress application of an excessive high voltage to the battery modules modn while minimizing the number of transformers.

In the above embodiment, the cut-off switch 9 is a service plug, so that the effects described below are obtained.

It is easy to perform inspection and maintenance (service) between the battery modules modn adjacent to each other.

In the above embodiment, the power supply system 1 does not include a sub-battery different from the assembled battery 3 (driving battery), so that the effects described below are obtained.

As compared with a case where a sub-battery different from the driving battery is provided, the number and the size of components can be reduced. For example, in a case where power generated by the solar cell while being left is charged in a sub-battery different from the driving battery, it is necessary to stop power generation of the solar cell when the sub-battery is fully charged. For example, when the sub-battery is fully charged, the monitoring system of the driving battery can be operated to discharge the sub-battery and charge the driving battery. However, when the power transfer frequently occurs between the driving battery and the sub-battery, the operation frequency of the monitoring system increases, and the power consumption increases. On the other hand, according to the present embodiment, since a sub-battery different from the driving battery is not provided, an increase in power consumption can be suppressed.

<Modifications of First Embodiment>

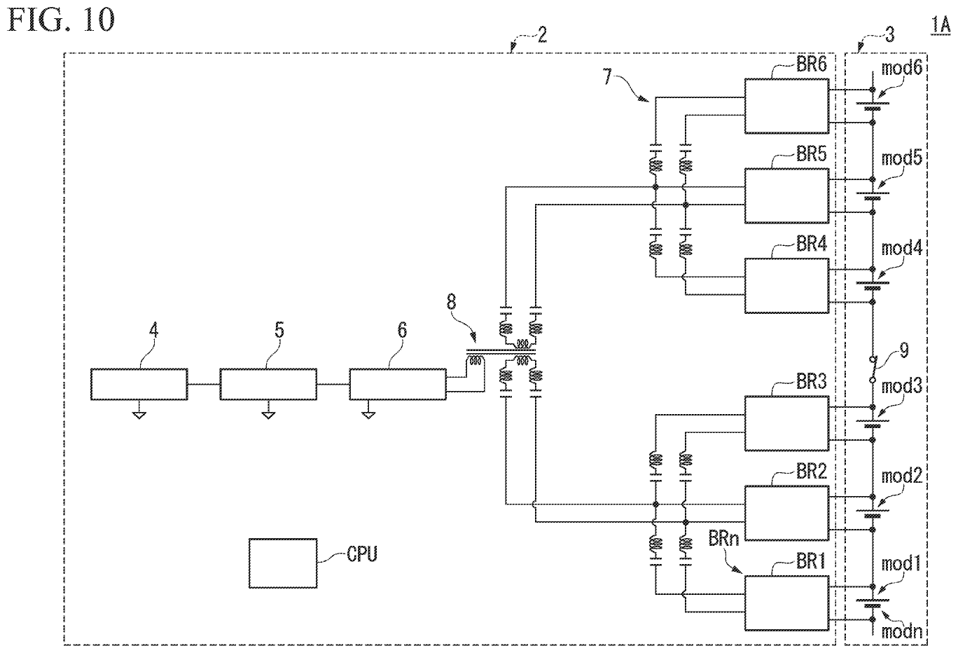

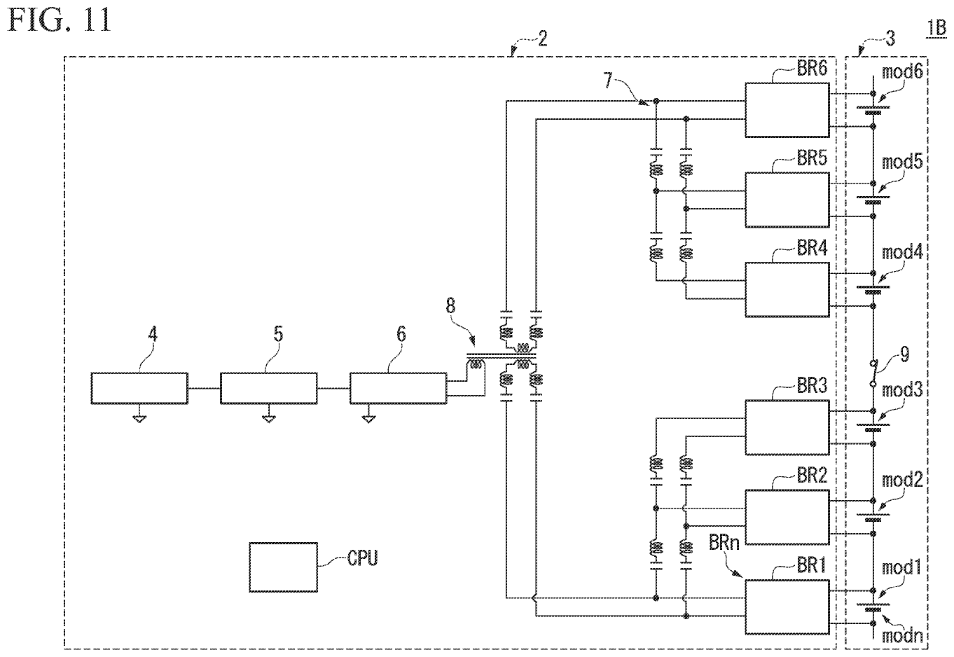

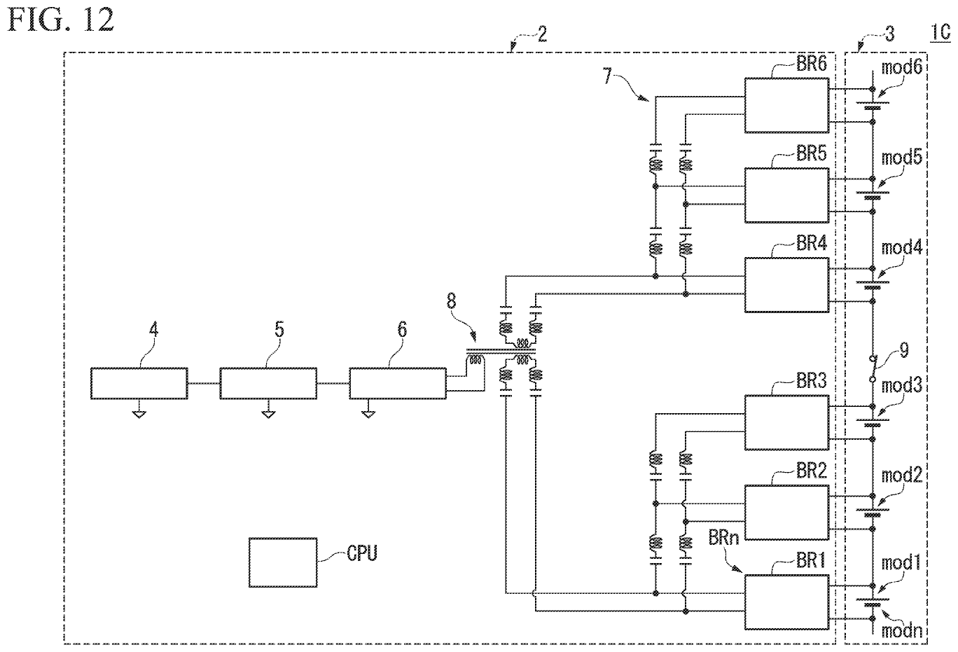

In the above-described embodiment, an example in which the connection point between the transformer 8 and the AC electric path 7 is disposed at the intermediate position where the cut-off switch 9 is provided has been described, but it is not limited thereto. For example, the connection point between the transformer 8 and the AC electric path 7 may be disposed at a position different from the intermediate position where the cut-off switch 9 is provided. For example, as illustrated in FIG. 10, in a power generation system 1A of a first modification, the connection point between the transformer 8 and the AC electric path 7 may be disposed at a position corresponding to the circuit modules BR2 and BRS. For example, as illustrated in FIG. 11, in a power generation system 1B of a second modification, the connection point between the transformer 8 and the AC electric path 7 may be disposed at a position corresponding to the circuit modules BR1 and BR6. For example, as illustrated in FIG. 12, in a power generation system 1C of a third modification, the connection point between the transformer 8 and the AC electric path 7 may be disposed at a position corresponding to the circuit modules BR1 and BR4.

<Second Embodiment>

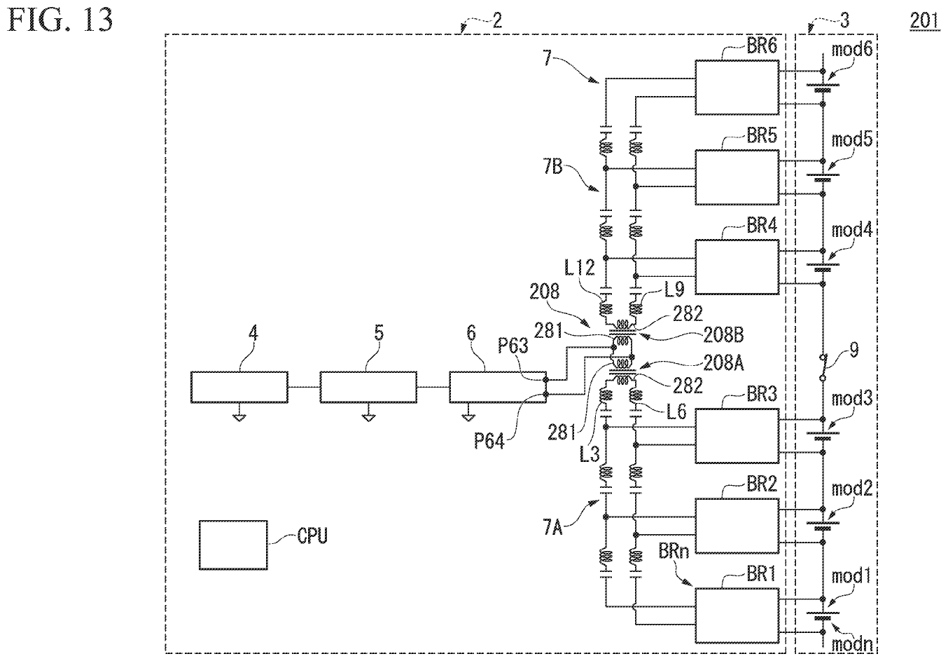

In the first embodiment, an example in which the transformer 8 includes only one three-winding transformer has been described, but it is not limited thereto. As illustrated in FIG. 13, the second embodiment is different from the first embodiment described above in the aspect of the transformer. Note that, in the following description, the same constitutions as those of the above-described first embodiment are denoted by the same reference numbers, and descriptions thereof will be omitted.

In a power generation system 201 of the second embodiment, a transformer 208 includes only two two-winding transformers. Hereinafter, one of the two two-winding transformers is referred to as a “first transformer” and the other is referred to as a “second transformer”.

Transformers 208A and 208B each include a first winding 281 and a second winding 282. The first winding 281 is provided on an input side (primary side) of the transformer 208. The second winding 282 is provided on an output side (secondary side) of the transformer 208.

The first winding 281 of each of the transformers 208A and 208B is connected to the AC generation circuit 6. In the example of FIG. 13, the first wiring extending from the first winding 281 of each of the transformers 208A and 208B is connected to the third terminal P63 of the AC generation circuit 6. The second wiring extending from the first winding 281 of each of the transformers 208A and 208B is connected to the fourth terminal P64 of the AC generation circuit 6.

The second winding 282 of the first transformer 208A is connected between the third inductor L3 and the sixth inductor L6 in the first electric path 7A.

The second winding 282 of the second transformer 208B is connected between the ninth inductor L9 and the twelfth inductor L12 in the second electric path 7B.

In the second embodiment, the plurality of loads includes the battery modules modn connected in series, the cut-off switch 9 is provided between the battery modules modn adjacent to each other, and the transformer 208 includes only two two-winding transformers, so that the effects described below are obtained.

When power is supplied from the solar power generation unit 4 to the plurality of loads, the power is supplied via only the two two-winding transformers. Even when the cut-off switch 9 is provided between the battery modules modn adjacent to each other, it is possible to suppress application of an excessive high voltage to the battery modules modn while reducing the number of transformers as much as possible.

<Third Embodiment>

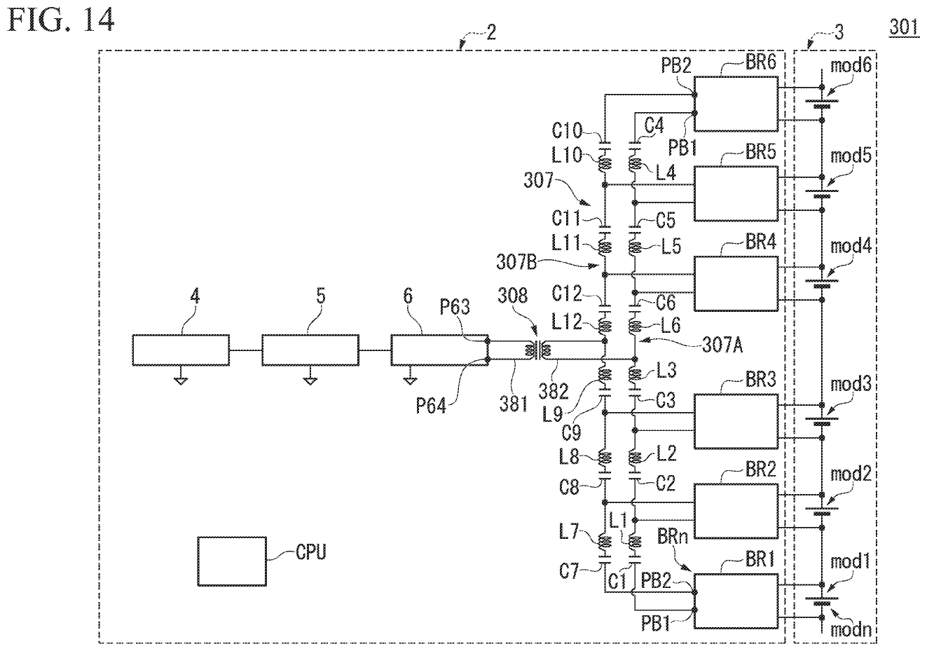

As illustrated in FIG. 14, the third embodiment is different from the first embodiment described above in the aspect of the transformer. In the third embodiment, the cut-off switch 9 is not provided between the battery modules modn adjacent to each other. Note that, in the following description, the same constitutions as those of the above-described first embodiment are denoted by the same reference numbers, and descriptions thereof will be omitted.

In a power supply system 301 of the third embodiment, a transformer 308 includes only one two-winding transformer.

The two-winding transformer includes a first winding 381 and a second winding 382. The first winding 381 is provided on an input side (primary side) of the transformer 308. The second winding 382 is provided on an output side (secondary side) of the transformer 308.

In the example of FIG. 14, two electric paths 307A and 307B (first electric path 307A and second electric path 307B) are provided as an AC electric path 307, and six capacitors C1 to C6 (first capacitor C1, second capacitor C2, third capacitor C3, fourth capacitor C4, fifth capacitor C5, and sixth capacitor C6) and six inductors L1 to L6 (first inductor L1, second inductor L2, third inductor L3, fourth inductor L4, fifth inductor L5, and sixth inductor L6) connected in series in a first system (on the first electric path 307A) and six capacitors C7 to C12 (seventh capacitor C7, eighth capacitor C8, ninth capacitor C9, tenth capacitor C10, eleventh capacitor C11, and twelfth capacitor C12) and six inductors L7 to L12 (seventh inductor L7, eighth inductor L8, ninth inductor L9, tenth inductor L10, eleventh inductor L11, and twelfth inductor L12) connected in series in a second system (on the second electric path 307B) are provided as a series circuit of capacitors and inductors.

As illustrated in FIG. 14, a first end of the first electric path 307A is connected to the first terminal PB1 of the first circuit module BR1. A second end of the first electric path 307A is connected to the first terminal PB1 of the sixth circuit module BR6.

A first end of the second electric path 307B is connected to the second terminal PB2 of the first circuit module BR1. A second end of the second electric path 307B is connected to the second terminal PB2 of the sixth circuit module BR6.

The first capacitor C1, the first inductor L1, the second capacitor C2, the second inductor L2, the third capacitor C3, and the third inductor L3 are disposed on the first electric path 307A in this order from the first end of the first electric path 307A toward the transformer 308 (second winding 382).

The fourth capacitor C4, the fourth inductor L4, the fifth capacitor C5, the fifth inductor L5, the sixth capacitor C6, and the sixth inductor L6 are disposed on the first electric path 307A in this order from the second end of the first electric path 307A toward the transformer 8 (second winding 382).

The seventh capacitor C7, the seventh inductor L7, the eighth capacitor C8, the eighth inductor L8, the ninth capacitor C9, and the ninth inductor L9 are disposed on the second electric path 307B in this order from the first end of the second electric path 307B toward the transformer 308 (second winding 382).

The tenth capacitor C10, the tenth inductor L10, the eleventh capacitor C11, the eleventh inductor L11, the twelfth capacitor C12, and the twelfth inductor L12 are disposed on the second electric path 307B in this order from the second end of the second electric path 307B toward the transformer 308 (second winding 382).

The first winding 381 is connected to the AC generation circuit 6. As illustrated in FIG. 14, a first end of the first winding 381 is connected to the third terminal P63 of the AC generation circuit 6. A second end of the first winding 381 is connected to the fourth terminal P64 of the AC generation circuit 6.

A first end of the second winding 382 is connected between the third inductor L3 and the sixth inductor L6 in the first electric path 307A.

A second end of the second winding 382 is connected between the ninth inductor L9 and the twelfth inductor L12 in the second electric path 307B.

In the third embodiment, the plurality of loads includes the battery modules modn connected in series, the cut-off switch 9 is not provided between the battery modules modn adjacent to each other, and the transformer 308 includes only one two-winding transformer, so that the effects described below are obtained.

When power is supplied from the solar power generation unit 4 to the plurality of loads, the power is supplied via only the one two-winding transformer. When the cut-off switch 9 is not provided between the battery modules modn adjacent to each other, it is possible to suppress application of an excessive high voltage to the battery modules modn while minimizing the number of transformers.

<Other Modifications>

In the above embodiments, an example in which the vehicle is an electric vehicle has been described, but it is not limited thereto. For example, the vehicle may be a hybrid electric vehicle having an engine. For example, the power supply apparatus may be applied to a train or the like. For example, the power supply apparatus may be applied to an apparatus or system other than the vehicle.

In the above embodiments, an example in which the power source is a solar power generation unit has been described, but it is not limited thereto. For example, the power source may be a power generation apparatus other than the solar power generation unit. For example, an aspect of the power source can be changed according to required specifications.

In the above embodiments, an example in which the cut-off switch is a service plug has been described, but it is not limited thereto. For example, the cut-off switch may be a mechanical switch other than the service plug. For example, an aspect of the cut-off switch can be changed according to required specifications.

In the above embodiments, an example in which the isolated DC/DC converter is not provided between the solar cell and the AC generation circuit has been described, but it is not limited thereto. For example, the isolated DC/DC converter may be provided between the solar cell and the AC generation circuit. For example, an aspect of installation of the isolated DC/DC converter can be changed according to required specifications.

Although preferable embodiments of the present invention have been described above, the present invention is not limited to these, and addition, omission, replacement, and other changes of constitutions can be made without departing from the gist of the present invention, and the above-described modifications can be appropriately combined.

### BRIEF DESCRIPTION OF THE REFERENCE SYMBOLS

2 Power supply apparatus
4 Solar power generation unit (power source)
6 AC generation circuit
7, 307 AC electric path
8, 208, 308 Transformer
9 Cut-off switch
modn Battery module (load)

What is claimed is:

1. A power supply apparatus for supplying power to a plurality of loads, the power supply apparatus comprising:
a power source;
an AC generation circuit which is connected to the power source and generates an AC voltage;
an AC electric path which is connected to the plurality of loads and to which the AC voltage is applied; and
a transformer which is provided between the AC generation circuit and the AC electric path,
wherein
an isolated DC/DC converter is not provided between the power source and the AC generation circuit.

2. The power supply apparatus according to claim 1, wherein
the plurality of loads include battery modules connected in series,
a cut-off switch is provided between the battery modules adjacent to each other, and
the transformer includes only one three-winding transformer.

3. The power supply apparatus according to claim 1, wherein
the plurality of loads include battery modules connected in series,
a cut-off switch is provided between the battery modules adjacent to each other, and
the transformer includes only two two-winding transformers.

4. The power supply apparatus according to claim 2 or 3, wherein the cut-off switch is a service plug.

5. The power supply apparatus according to claim 1, wherein
the plurality of loads include battery modules connected in series,
a cut-off switch is not provided between the battery modules adjacent to each other, and
the transformer includes only one two-winding transformer.

6. The power supply apparatus according to claim 3, wherein the cut-off switch is a service plug.
